(19) United States
(12) Patent Application Publication
(10) Pub. No.: US 2016/0249096 A1
(43) Pub. Date: Aug. 25, 2016

(54) METHODS AND SYSTEMS ENABLING ACCESS BY PORTABLE WIRELESS HANDHELD DEVICES TO AUDIO AND OTHER DATA ASSOCIATED WITH PROGRAMMING RENDERING ON FLAT PANEL DISPLAYS

(71) Applicants: Isabella V. Ortiz, Albuquerque, NM (US); Sofia A. Ortiz, Albuquerque, NM (US); Luis Miguel Ortiz, Albuquerque, NM (US); Luis M. Ortiz, Albuquerque, NM (US)

(72) Inventors: Isabella V. Ortiz, Albuquerque, NM (US); Sofia A. Ortiz, Albuquerque, NM (US); Luis Miguel Ortiz, Albuquerque, NM (US); Luis M. Ortiz, Albuquerque, NM (US)

(21) Appl. No.: 14/631,029

(22) Filed: Feb. 25, 2015

(51) Int. Cl. H04N 21/4363; H04N 21/439; H04N 21/4367; H04N 21/45; H04N 21/414; H04N 21/41

(52) U.S. Cl. CPC H04N 21/43637; H04N 21/41415; H04N 21/4126; H04N 21/4367; H04N 21/4516; H04N 21/439

(57) ABSTRACT

Video data rendering devices (e.g., flat panel displays such as Smart TVs, set top boxes, and media dongles) can wirelessly broadcast their identity for discovery to portable wireless electronic devices (e.g., smartphones, tablets) interested in obtaining audio and other data associated with video programming displayed on the video data rendering devices. An application can be downloaded and activated on portable devices that will enable them to obtain a list of available (discovered) video data rendering devices (multiple screens, depending on venue) and allow wireless access to audio and data associated with displayed video programming. A video data rendering device of interest can be selected by the portable device and it can access data in addition to audio (either directly from the flat panel or from a remote server once the video data rendering device or the data has been identified) and/or engage in an interactive session.

### FIELD OF THE INVENTION

The present invention is generally related to wireless handheld devices such as smartphones and also to flat panel displays such as smart TVs. The present invention is also related to the exchange of data between devices. More particularly, the present invention is related to methods and systems enabling access to audio and other data associated with video programming rendering on flat panel displays by portable wireless handheld devices located near the flat panel displays.

### BACKGROUND

Television has been around for a long time. So has the problem of being able to hear a video program playing on a television set when the volume has to remain low, the television is in a loud environment, or the language is not familiar. The audio volume must sometimes be kept low in the privacy of a home so that other occupants in the home (e.g., sleeping baby or spouse) are not disturbed by the sound. The same audio concern applies to shared room in hospitals. In a sports bar or other loud venue where several television monitors are playing a variety of programming, only a few programs (e.g., a key football game or other event) may be playing with audio while others are only being displayed without audio. Finally, video programming with audio may be using a default language (e.g., English), yet the crowd may include several people that primarily speak and understand another language (e.g., Spanish). Although there are analog solutions available that can connect an rf transmitter to the analog audio output on a television set that transmits the audio wirelessly at a short range to a matching rf receiver integrated in headphones, this is a narrow analog solution that is not available or easily adaptable for use in public venues such as sports bars. What is needed is a more simplified means of solving these problems where users do not need more equipment that they may already have and be carrying around on a regular basis.

Television sets today can be connected to data networks (e.g., the Internet) and are being marketed as “Smart TVs” because of their data network accessing capabilities, as well as the smartphone-like user interfaces they provide. Smart televisions and smartphones have only recently been able to interact with what is being referred to as “second screen” applications; however, applications that are currently available are limited to the wireless rendering of data that is either provided from a smartphone onto the screen of a flat panel display utilizing small gateway and video streaming devices (e.g., boxes or dangles connectible via HDMI or USB connections integrated on the flat panel displays) such those provided by Apple (e.g., Apple TV's Airplay) and Roku, or where data associated with programming displayed on the flat panel display is accessed from a remote server (i.e., website) only after identifying a program being watched on a large flat panel display to the server by name or access code. Media sharing to flat panels directly from handhelds to flat panels has also been enabled using other wireless means or standards such as DLNA via a router, and directly with flat panel devices using WIFI direct, which has recently been accomplished with applications such as Multiscreen Play (by Hisense), AllJoyn and Snapdragon (by Qualcomm), Content Share (by Haier), Miracast (by Panasonic), SmartShare (by LG), and others. Yet all of these applications are only described for use in sharing data in one direction—from handheld devices to larger flat panel devices. U.S. Pat. No. 8,971,914 entitled “Systems, Methods and Apparatuses for Providing Video Data to Data Rendering Devices for Display on Multimedia Video Devices at the Request of Wireless Hand Held Devices”, which issued to Luis M. Ortiz, describes data mirroring in the context of the foregoing technology.

As of the priority filing date of this invention, a flat panel display (Smart TV) is not known to include a wireless data module adapted to provide audio directly to portable electronic devices, such as smartphones and tablet computers, following a request initiated at the portable electronic device. All current data delivery appears limited to what is provided from the portable electronic device to a data network-enabled flat panel display (hereinafter also referred to as “FP”) typically mounted or sitting in a fixed position within homes, hospitals, sports bars, and other publicly accessible venues. Data is typically provided from portable wireless electronic device to flat panel displays by utilizing the screen/data sharing technologies describe above. There is currently no intermediary device or application that can identify audio that is available for smartphone retrieval based on what is being displayed on flat panel displays.

An especially problematic audio data access problem presents itself in a scenario where there are several screens displaying multimedia data to spectators located in a public venue (e.g., a sports bar, sports stadium, casino sports book, etc.) rather than a private den or office. Solutions are not currently available for spectators utilizing wireless handheld devices to simultaneously access/select audio associated with video programming that is being displayed on a particular screen chosen from several screens co-located at the venue whereon various other video programming is also being displayed. The present inventors believe that spectators/observers at a public venue would like the ability to access audio associated with specific video content being displayed on a particular flat panel display chosen from several flat panel displays showing different video programming, especially because it may be difficult to hear the audio associated with the desired programming in a loud and busy environment that you typically find in a sports bar or other heavily attended/trafficked venue, or because the particular video programming of interest is not what is being amplified for all attendees to hear at the venue, or furthermore, because the audio is not being amplified in a language of preference.

### SUMMARY OF INVENTIVE FEATURES

It is, therefore, a feature of the present invention to enable portable wireless electronic device users to select a flat panel display, or a separate box/dongle providing video to the flat panel display, and connect with the flat panel/box/dangle (herein together identified as video data rendering devices or VDRDs) and access audio associated with particular video programming being rendered on the VDRD.

It is yet another feature of the present invention to enable more than one portable wireless electronic device user to select a VDRD to connect with and simultaneously access audio associated with particular video programming being rendered on the VDRD.

It is another feature that audio can be accessed in more than one language if more than one language is being provided with the particular video programming.

It is another feature that audio can be accessed by portable wireless electronic devices together with textual or video data being rendered on the VDRD.

It is another feature that textual data that can be provided with audio can be in the form of closed-captioning text associated with the video data being rendered on the VDRD, and the text can be streamed on a display screen integrated in the portable wireless electronic device.

It yet is another feature that audio can be accessed while the portable wireless electronic device can also engage in an interactive data exchange session associated with the video programming being rendered on a selected VDRD.

It is another feature of the present invention to enable VDRDs to broadcast their identity via wireless communications (e.g., Bluetooth, or WiFi direct) to portable wireless electronic devices utilizing an application that enables VDRD discovery and supports interaction with VDRDs that are discovered and chosen by the portable wireless electronic devices.

It is another feature of the present invention to enable portable wireless electronic devices to wirelessly discover, select, and obtain audio from a selected VDRD rendering video data and associated information and that the video can be broadcasted (e.g., Bluetooth broadcast of streaming audio packets) over data connections to multiple portable wireless electronic devices using Bluetooth, WiFi or other packet data transport means capable of broadcasting data to more than at least one portable wireless electronic device.

What is needed is a way for a portable wireless electronic device to easily select a VDRD screen that is rendering a particular video programming thereon from among several co-located VDRD screens rendering different video programming, and enable access by portable wireless electronic devices to audio associated with the particular video programming content being displayed on the VDRD display screen. Users can thereby listen to audio on their portable wireless electronic devices while simultaneously viewing video rendering directly on the VDRD screen and that is associated with the audio being heard on the portable wireless electronic devices.

In accordance with features of the preset invention, VDRDs can be enabled to wirelessly broadcast (e.g., via Bluetooth broadcasting) their identity for discovery by portable wireless electronic devices and can also identify data associated with the content being displayed on the VDRDs to multiple users of the portable wireless electronic devices (e.g., smartphones, tablet computers). This capability can be referred to as mediacasting, or Mediacast-enabled with respect to aspects of the mediacasting capability directly incorporated into VDRDs. Data can include video, text, audio, and identifying information needed to access such data from a remote server. Portable wireless electronic device users can activate an application on their portable wireless electronic devices that will enable them to see (discover) a list of available VDRDs (often multiple screens, depending on venue) that allow wireless access by the portable wireless electronic devices to audio associated with video data being displayed on the VDRD of interest to the portable wireless electronic device user. The portable wireless electronic device users can select the VDRD screen of interest (or data for the screen of interest) and access additional data (either directly from the VDRD or from a remote server once the data has been identified) andlor engage in an interactive session in association with the displayed data.

In accordance with additional features of the present invention, possible venues that can deploy the mediacasting concept disclosed herein are: sports bars, sports venues, educational institutions, casino sports books, shopping centers, amusement parks, hospitals, homes, and the like.

In accordance with yet another feature of the present invention, an application (“APP”) that enables portable wireless electronic devices to interact with Mediacast-enabled VDRDs can be downloaded from a server associated with application providers (e.g., Apple, Google Android, etc.).

Wireless standards that can be used to implement the invention include Bluetooth and WiFi direct.

Portable wireless electronic devices such as laptops could also be used to access data under the teaching described herein.

### BRIEF DESCRIPTION OF THE FIGURES

FIG. 1 illustrates a system enabling VDRD discovery by portable wireless electronic devices for access to audio and other data associated with video programming being displayed on a screen associated with the VDRD selected by portable wireless electronic devices;

FIG. 2 illustrates a system enabling VDRD discovery by a portable wireless electronic device and access to data associated with programming displayed on a display screen of a particular VDRD selected by a portable wireless electronic device when several VDRDs rendering different video programming are also located near the portable wireless electronic device;

FIG. 3 illustrates a system deployed in a large venue such as a sports stadium that utilizes wireless infrastructure at the venue to broadcast available data including audio associated with programming being displayed on VDRDs located throughout the large venue and can also enable access by portable wireless electronic devices to the data associated with programming displayed on a display screen of a particular VDRD (e.g., flat panels deployed in a private suite location) selected by a portable wireless electronic device when several VDRDs are also located near the portable wireless electronic device in accordance with features of the present invention;

FIG. 4 illustrates a screen shot from a portable wireless electronic device illustrating a list of VDRDs wirelessly discovered for access to broadcasted audio and other data therefrom by portable wireless electronic devices;

FIG. 5 illustrates a screen shot from a portable wireless electronic device illustrating a list of audio associated with video programming being rendered on a display screen associated with a VDRD selected by the portable wireless electronic device;

FIG. 6 illustrates a block diagram of steps that can be followed for discovering a VDRD with a portable wireless electronic device and accessing audio associated with video programming displayed on a display screen associated with the selected VDRD; and

FIG. 7 illustrates a block diagram of steps that can be followed for enabling discovery of a VDRD by portable wireless electronic devices and for providing audio data associated with video programming displayed on a display screen associated with the VDRD selected by the portable wireless electronic device.

### DETAILED DESCRIPTION OF THE INVEI INVENTION

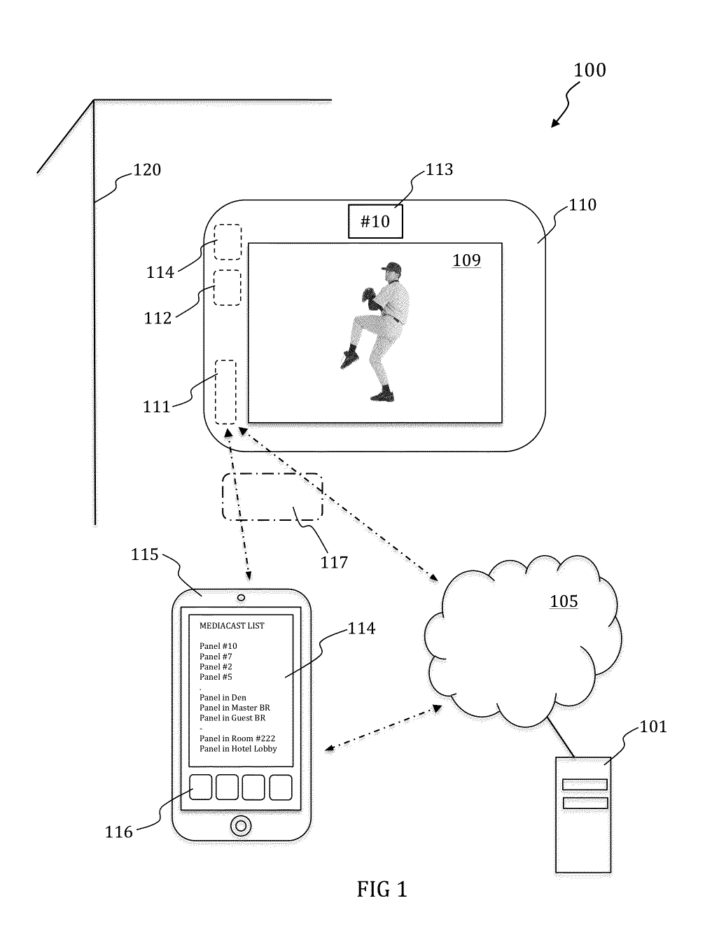

FIG. 1 illustrates a system 100 enabling flat panel display or associated set top box/dangle (herein after collectively referred to as “VDRD”) discovery by portable wireless electronic devices 115 and providing the portable wireless electronic devices 115 access to audio and other data associated with programming displayed on a display screen associated with the VDRD 110 that is, selected by at least one portable wireless electronic device 115. A VDRD 110 can have access to a data network 105 to retrieve programming and information from a remote server 101, either directly by a flat panel display or via devices like Apple TV, Roku, and other set top boxes 117. It should be appreciated that VDRD functionality can reside in a set top box 117 rather than the flat panel display generally indicated by 110, in which case all modules described herein to enable VDRD functionality would also reside in the set top box 117 (or a HDMI/USB dongle if appropriate). For this reasons, description of a VDRD should be read to encompass either integration is a smart TV enabled flat panel displays or separate set top boxes/dongles, or both, either which can be used in conjunction with video data to render the video on a display screen typically integrated in a flat panel display such as a smart TV.

The VDRD 110 can also have an internal (built-in) wireless communication module 111 (e.g., WiFi or Bluetooth, or both) to support communications with nearby portable wireless electronic devices 115 or to obtain further data access from the network 105 in the same manner as a connected device like Apple TV or Roku would through application software and a data network connection. The VDRDs can include a memory 112 that can have VDRD identifying information, profile information, can function as a queue to store programming displayed on a display screen (e.g., LCD, LED, Plasma, or the like) associated with the VDRDs, and which can include a limited amount of past programming previously displayed by a display screen associated with the VDRD 110. A media format module 114 can also be provided to enable processing of and access to other languages or closed caption data that may be provided with the video programming that is being rendered by the VDRD 110. Some video programming may include alternate language or closed captioning, in which case alternate formats can be chosen remotely by the portable wireless electronic devices 115. The language module can enable the remote selection of formatting by the portable wireless electronic device 115.

The wireless communication module can wirelessly broadcast identifying information 113 identifying the VDRD 110 to nearby portable wireless electronic devices 115. The identifying information 113 can be an identification number (screen labeled #10, as shown) physically located on or near a VDRD 110 (e.g., on the housing of a flat panel display near the display screen) that can be read by spectators, or as electronic identifying information broadcasted about the physical location of the flat panel 110 in a venue 120, and broadcast information about programming being displayed on the VDRD 110. The broadcast of wireless-enabled device identities is common for WiFi hotspots and Bluetooth connected devices, where identifying information is periodically sent for receipt by portable wireless electronic devices in search of a wireless data connection to other electronic devices; however, VDRDs do not currently broadcast identifying information (in particular, after-market labels or physical location information), and information broadcasted from other wireless data enabled devices today are not used for purposes of obtaining data associated with programming displayed on VDRDs where numerous other VDRDs may also be co-located (located next to each other) in a crowded venue (e.g., a sports bar, casino or sports stadium). For example, a Bluetooth module can be implement into a VDRD and can be set up and programmed up to enable broadcasting of audio data in a manner that streams packets of audio associated with the video programming to multiple portable wireless electronic devices once the particular VDRD is selected by portable wireless electronic devices to receive the packet data formatted audio broadcast. Access to audio will begin at the point that is it being broadcasted in sync with the video being displayed in a broadcast configuration, rather than the user receiving the audio programming from the beginning of the selected video program. Video streams that are accessed in public venues or airplane media services are an example of multiple users obtaining access to packet data streamed content where the packets are received at the real time point of the video program selected for viewing. What is different in the present invention, however, is that audio is being separated from the video program and is being provided (accessed by) wirelessly to portable wireless electronic handheld devices.

VDRDs 110 enabled with a wireless communication module 111 can be programmed, or otherwise set up via profile information or system preferences, using a mediacasting application to broadcast identifying information rather than just the manufacturer and model information. Manufacturer and model information would be useless if simultaneously broadcasted via Bluetooth from, for example, ten flat panel devices in a sports bar that are made by the same manufacturer and are the same model. This is why the use of unique identifying information is necessary in accordance with features of the present invention. Information will be described in further detail below, but can include setting up the VDRD profile with physical location, relying on programming information obtained from an electronic tag in association with a program or a name/label physically attached to the VDRD to assist users in identification of the desired VDRD to interact with using a portable wireless electronic device.

The portable wireless electronic devices 115 can be provided in the form of a smartphone (e.g., iPhone, Android-based smartphone) or tablet (e.g., iPad) and include an application 116 that enables the discovery of available VDRDs 110 near the portable wireless electronic device 115. Discovery can be accomplished by the portable wireless electronic devices wirelessly receiving identifying information 113 for a VDRD in a list of available VDRDs 114. The VDRD 110 can be selected on the portable wireless electronic device 115, and the portable wireless electronic device 115 can then begin receiving audio and other data associated with programming displayed at the VDRD 110. The portable wireless electronic device 115 can also interact with programming displayed at the VDRD 110 via the application 116.

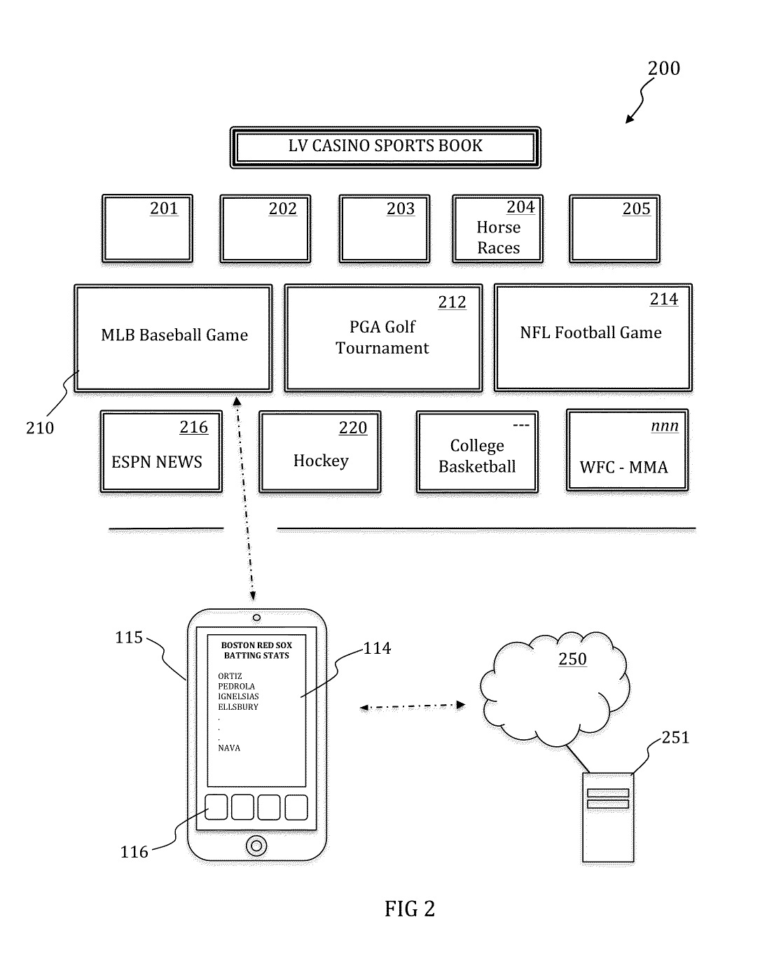

FIG. 2 illustrates a system 200 enabling a particular VDRD's discovery and access to audio and data associated with programming displayed on a particular VDRD 210 selected by a portable wireless electronic device 115 when several VDRDs 201, 212, 216, . . . nnn are also located near the portable wireless electronic device 115 and the VDRD 210 of interest. Such a scenario would be common in a publicly accessible venue, such as a sports bar or casino sports book where multiple VDRDs rendering various programming are available. In this type of scenario, a Mediacast application 116 can be opened on the portable wireless electronic device 115 that will enable the portable wireless electronic device 115 to locate the VDRD 210 of interest from among several VDRDs that are also broadcasting their identities.

Identities can be determined numerically and based on content. Numerical identification can first be physical (e.g., by a user reading a number marked on the housing of a flat panel surrounding a video display) and then electronic, based on information obtained physically. Identification can also be based on physical location information (e.g., “60 inch Sony-above cash register-over bar”). Identification can also be based on programming (e.g., “LA Lakers”, “Dodgers” or “HDTV”). It is entirely possible that the same video programming of interest will be displayed on multiple VDRDs located at the same venue. It this case, any of the VDRDs 212 displaying the same video programming of interest can be selected for audio and other data retrieval by, and/or interaction with, the portable wireless electronic device 115. Once common programming information of interest is identified (i.e., the same football game, regardless of the flat panel used to identify it), the portable wireless electronic device 115 can selectively retrieve audio from the selected VDRD and optionally other data related to the programming from the VDRD or form a remote server 251 via a wireless data network.

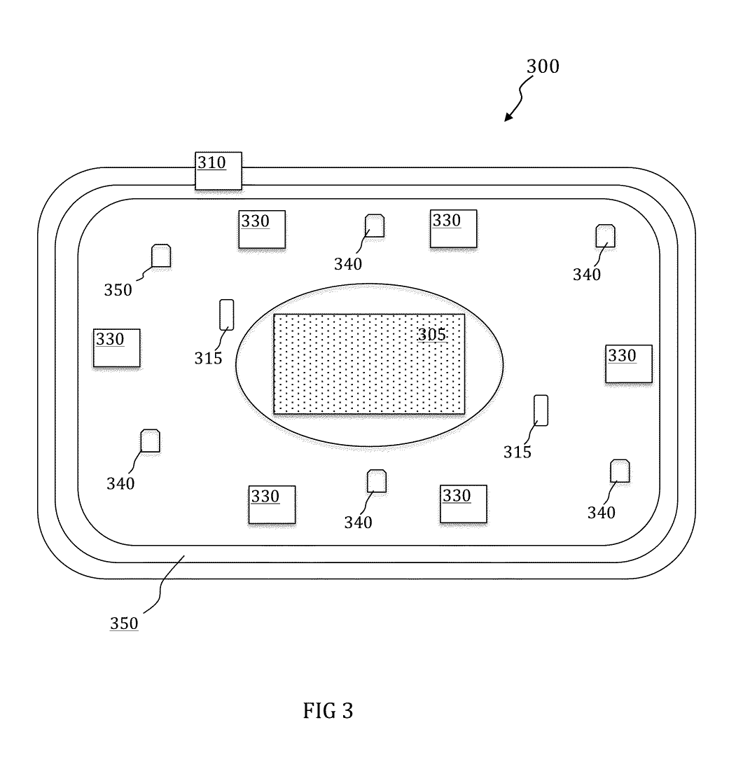

FIG. 3 illustrates a system 300 deployed in a large venue 350 such as a sports stadium that utilizes wireless infrastructure including hotspots 340 at the venue to broadcast available audio associated with programming being displayed on VDRDs 330 located throughout common areas of the large venue to portable wireless electronic devices 315 also located at the venue 350, and can also enable access to other data (e.g., statistics, history, product information, etc.) associated with programming displayed on a particular VDRD 310 (e.g., flat panel displays deployed in a private suite location) selected by portable wireless electronic device 315 when several VDRDs are also located near the portable wireless electronic device in accordance with features of the present invention. Wireless infrastructure can include hotspots deployed throughout the large venue.

U.S. Pat. No. 8,320,820 issued to Ortiz, co-inventor of the present invention, entitled “Self-contained data communication system nodes as stand-alone pods or embedded in concrete walkways and in walls at public venues including sports and entertainment venues” describes hotspots deployed in a sports venue to enable handheld device access to venue-related data. U.S. Pat. No. 8,320,820, which can be utilized to implement certain novel features of the present invention, is hereby incorporated by reference in its entirety for its teaching. The hotspot pods described by Ortiz can be adapted with mediacasting capabilities as described herein to provide portable wireless electronic device users with a list of audio and other data related to programming being displayed on VDRDs in the venue that is available for retrieval by the portable wireless electronic devices, or the availability of interaction with the programming that is being displayed. With the present invention, the skilled can imagine a multi-participant interactive session (e.g., gaming, social networking) that is directly associated with programming being displayed on VDRDs located at a venue.

In accordance with features of the present invention, a system deployed in a sports stadium 350 can enable sports fans using portable wireless electronic devices 315 to receive audio associated with the video programming of interest being displayed on a VDRD 310 selected by the user's portable wireless electronic device 315 to also interact with media being displayed on VOROs at the venue to retrieve instant replays, statistics, and other data based on programming being viewed on numerous VDRDs 330 typically located within such a venue 350. A football fan, for example, can listen to audio of interest and also re-watch an instant replay for a programming he just viewed on a VDRD 310 located near his seat; a baseball fan can review additional facts statistics for an athlete shown on a flat panel 310 that is currently at bat. The invention benefits all sports (basketball, soccer, ice hockey, tennis) so long as VDRDs 330 exist in the venue and are displaying active programming to attendees. Programming information can also be used by the portable wireless electronic device 315 to retrieve additional information from a remote server as previously described.

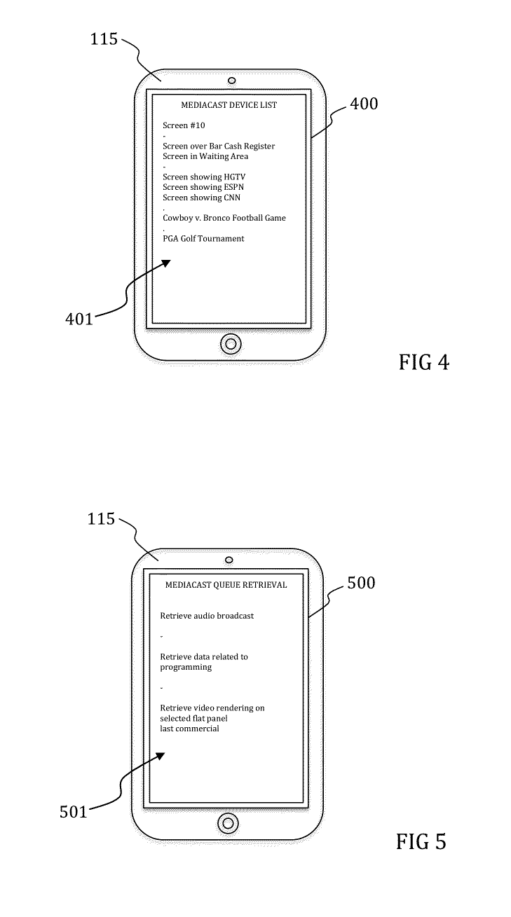

FIG. 4 illustrates a screen shot 400 from a portable wireless electronic device 115 illustrating a menu-like list 401 of VDRDs that were wirelessly discovered by the portable wireless electronic device 115 for access to audio and other data therefrom. A portable wireless electronic device user can select a VDRD from a list of VDRDs based on the portable wireless electronic device user's programming of interest. Once selected, the portable wireless electronic device 115 will be engaged in an audio data broadcast, data supplemental retrieval and/or interaction session with the VDRD. Audio and other non-audio-based data can be retrieved based on real-time programming that is being displayed on a VDRD, or for programming that was recently displayed, but has now passed (e.g., a commercial that has already passed, an instant replay of a live sports game, or statistical information about an athlete). Referring to FIG. 5, a screen shot 500 is shown from a portable wireless electronic device 115 that can provide a list of past programming 501 accessible from a queue (memory) associated with a selected VDRD that can still be selected and data retrieved by the portable wireless electronic device. This aspect of the invention is of high value in sports media where fast moving games can cause a sports fan to miss an important play or statistical information about an athlete or team that has already passed the screen. A user can be provided with limited access to past programming from a queue associated with the flat panel device; however, a menu of past programming as described with respect to FIG. 5 will simplify access to desired information by users. The listing can be provided in the form of time (e.g., “rewind 30 seconds”, “rewind 1 minute”, “rewind 2 minutes”) or based on identifying information (e.g., “last commercial”, “2^{nd}-last commercial”, “3^{rd} last commercial”). Alternatively, the content can be displayed as recorded video with a scroll bar that can include “pause”, “play”, “forward”, and “rewind” capabilities, similar to that provided for reviewing Youtube videos. The display of stored video content previously displayed by the VDRD and stored in the queue can also be enhanced with image tiles that pop up as the user moves along the scroll bar to help the user focus in on images for the video location that the user wants to review from the queue. Once the proper content is identified, the user can access data associated with the past programming/content.

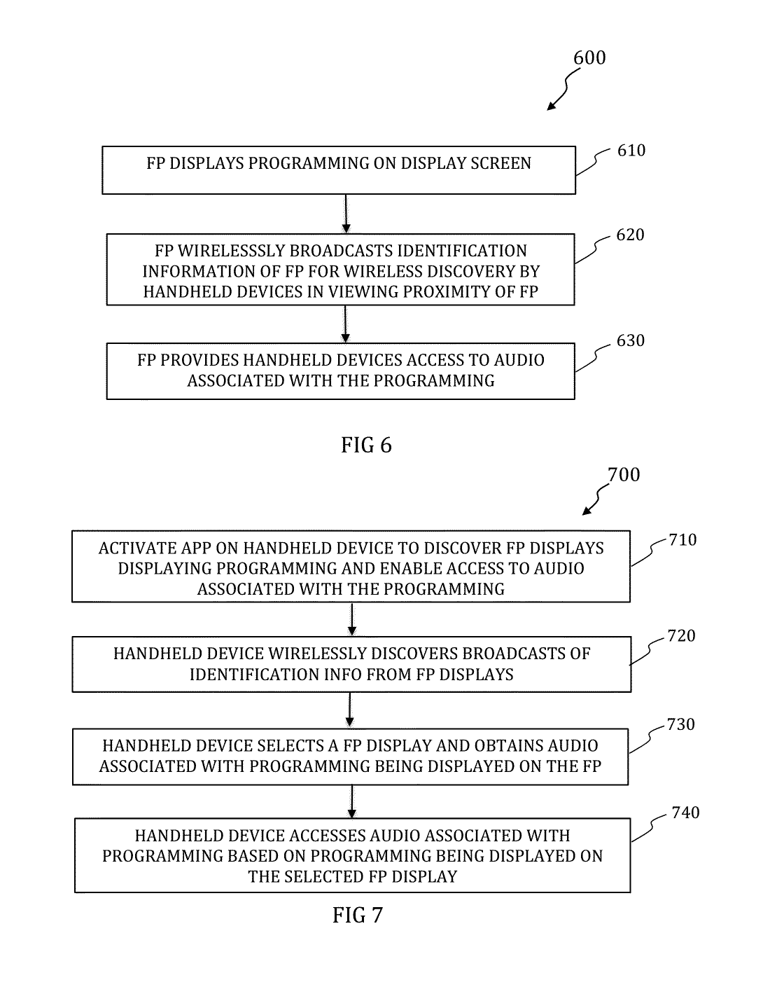

FIG. 6 illustrates a block diagram 600 of steps for discovering a VDRD with a portable wireless electronic device and accessing audio associated with programming displayed on the VDRD. As shown in block 610, a VDRD displays video programming on a display screen integrated in the VDRD. In block 620, the VDRD wirelessly broadcasts its identification for wireless discovery by portable wireless electronic devices. Then at block 630, the VDRD provides the portable wireless lectronic devices access to audio associated with the video programming.

FIG. 7 illustrates a block diagram 700 of steps enabling discovery of a VDRD by portable wireless electronic devices and for providing data associated with video programming being displayed on a display associated with a VDRD to portable wireless electronic devices. As shown in block 710, an application (Mediacast application) can be activated on a portable wireless electronic device to discover VDRDs that are displaying video programming on a display screen integrated in a VDRD of interest and enabling access to audio associated with the video programming. The portable wireless electronic device then wirelessly discovers broadcasts of identification information from the VDRDs, as shown in block 720. The portable wireless electronic device can then be used to select a VDRD and obtain audio associated with video programming being displayed on the VDRD, as shown in block 730. Additional data can be obtained with the audio (e.g., video, replay, etc.), but the portable wireless electronic device can also use information obtained from the VDRD to then access additional data from other sources (e.g., a server) that is associated with the video programming being displayed on the selected VDRD, as shown in block 740.

Audio can be provided in more than one language. For example, although audio associated with video being displayed on a VDRD may be in English, a portable wireless electronic device can wirelessly find, select, and retrieve audio in at least one other language (e.g., Spanish) that may be supported by the programming being displayed on the VDRD. Further, closed captioning can be provided as the “other data” that can be obtained in addition to audio in association with the video programming being rendered on the VDRD that is selected by a portable wireless electronic device. Closed captions are a text version of the spoken part of a television, movie, or computer presentation. Closed captioning was developed to aid hearing-impaired people, but it's useful for a variety of situations.

It should be appreciated from the foregoing disclosure that the methods and systems described herein can be utilized in various environments including private offices or living rooms and public venues such as sports bars, casinos, sports stadiums, shopping centers, amusement parks, transportation terminals, educational institutions, and others.

1. A method enabling access by portable wireless electronic devices to streaming data including audio in different languages and associated with video programming rendering on display screens associated with video data rendering devices located near the portable wireless electronic devices, comprising:
displaying video programming on a display screen of a flat panel display associated with a video data rendering device;
wirelessly broadcasting identification information from a video data rendering device associated with the flat panel display, said video data rendering device also providing at least one of: data identifying at least one of the flat panel display's identity based on a label affixed to the flat panel display, the flat panel display's name, and the flat panel display's location within a venue, wherein said identification is broadcasted for wireless discovery of the identification information by the portable wireless electronic devices located within wireless local area network range of the flat panel display;
connecting the video data rendering device with the at least one handheld wireless device after the at least one handheld wireless device discovers and selects the broadcasted identification information associated with the flat panel display; and
providing the at least one portable wireless electronic device with wireless access to the audio associated with the video programming identified by the video data rendering device as the video programming displaying on the display screen of the flat panel display, and the audio is provided in a language selected by the at least one portable wireless electronic device after the video data rendering device and the language is selected by the at least one portable wireless electronic device for retrieval of the audio.

2. The method of claim 1, wherein the wirelessly broadcasting the identification information occurs using Bluetooth network communications.

3. The method of claim 1, wherein the wirelessly broadcasting the identification information occurs via Bluetooth network communications and wireless access to the streaming data is from a remote server and occurs using cellular data communications with a remote server.

4. The method of claim 1, wherein access to data in addition to the audio that is associated with the video programming includes video segments associated with the video programming and is obtained by the at least one portable wireless electronic device wirelessly from a remote server over a wireless data communications network.

5. The method of claim 1, wherein access to data in addition to audio that is associated with the video programming includes video segments and is provided to the at least one portable wireless electronic device from the video data rendering device.

6. (canceled)

7. The method of claim 1, wherein data in addition to the audio that is associated with the video programming includes closed captions in more than one language.

8. The method of claim 6, wherein the wirelessly broadcasting of identification information for wireless discovery of video data rendering devices by portable wireless electronic devices occurs using at least one of Bluetooth and WiFi network communications.

9. The method of claim 4, further comprising the step of supporting an interactive session between the portable wireless electronic devices and the video data rendering devices in association with the video segments of the video programming of a selected video data rendering device and includes at least one command with respect to the video segments of: replay, play, rewind, pause, forward.

10. The method of claim 9, wherein the interactive session between the portable wireless electronic devices and the video data rendering devices is supported over at least one of Bluetooth and WiFi communications.

11. A method enabling portable wireless electronic device access to streaming data including audio in different languages and associated with video programming rendering on display screens associated with video data rendering devices, comprising:
activating an application on a portable wireless electronic device to enable wireless discovery of at least one video data rendering device that is displaying video programming on a display screen associated with a video data rendering device and also enables access to streaming data including audio associated with the video programming;
wirelessly discovering broadcasts of identification information with the portable wireless device from the at least one video data rendering device, said at least one video data rendering device providing at least one of: data identifying at least one of a flat panel display's identity based on label affixed to the flat panel display, a flat panel display's name, and a flat panel display's location within a venue, wherein the identification information is broadcasted for wireless discovery of the identification information by portable wireless electronic devices when they are located within wireless local area network range of the video data rendering device;
selecting a video data rendering device with the portable wireless electronic device and connecting to the video data rendering device with the portable electronic handheld wireless device after the portable electronic handheld wireless device discovers and selects the broadcasted identification information associated with the flat panel display; and
obtaining the audio associated with the video programming with the portable wireless electronic device from the selected video data rendering device in a language selected by the portable wireless electronic device.

12. The method of claim 11, wherein the step of obtaining the audio associated with the video programming from the selected video data rendering device occurs using cellular data network communications.

13. The method of claim 11, wherein the step of wirelessly discovering broadcasts of identification information for at least one video data rendering device occurs using Bluetooth, and access to the data is from a remote server via Cellular data network communications.

14. The method of claim 13, further comprising the step of accessing other data including video segments associated with the video programming, wherein access to the other data occurs using cellular data network communications.

15. The method of claim 14, wherein the other data is accessed from at least one of the at least one of the video data rendering device or a remote server.

16. The method of claim 14, further comprising the step of supporting an interactive session between the portable wireless electronic device and the at least one video data rendering device in association with the video segments of the video programming, and the interactive session includes at least one command with respect to the video segments including one of: replay, play, rewind, pause, forward.

17. The method of claim 16, wherein the interactive session is supported over at least one of Bluetooth and WiFi communications.

18. A video data rendering device placed in a stationary location in a venue to enable the display of video programming on a display screen and the provision of data including audio in different language to portable electronic devices located near the video data rendering device, comprising:
access to a data network; and
at least one wireless data communications module supporting communication with at least one portable wireless electronic device;
video data rendering device identification information provided in the form of at least one of: electronic identification of location or name of a flat panel device contained in a memory, and physical identification of a flat panel by letter or number;
wherein said wireless data communication module broadcasts the video data rendering device identification information to portable wireless electronic devices requesting video data rendering device identification information association with video programming interest being rendered by the video data rendering device and enables the portable wireless electronic devices to obtain audio in a select language and at least one of video segments and other data from at least one of the video data rendering device and a remote server via at least one of the wireless data communications module and a wireless data network.

19. The video data rendering device of claim 18, wherein said at least one wireless data communications module includes at least one of a Bluetooth and WiFi network communications transceiver providing the portable wireless electronic devices access to at least one of the audio and the other data associated with the video programming.

20. The video data rendering device of claim 18, further comprising a media format selection module wherein the media format selection module enables at least one of audio to be obtained by the portable wireless electronic devices in an alternate language and access to closed caption data for display on the portable wireless electronic devices.
